(19) United States
(12) Patent Application Publication
(10) Pub. No.: US 2009/0226108 A1
(43) Pub. Date: Sep. 10, 2009

(54) MULTI-PASS ALGORITHM TO REDUCE RINGING ARTIFACTS IN NOISE REMOVAL AND DEBLUR EFFECTS

(76) Inventor: Benjamin Kent, London (GB)

Correspondence Address: PERKINS COIE LLP, P.O. BOX 1208, SEATTLE, WA, 98111-1208, US

(21) Appl. No.: 12/056,544

(22) Filed: Mar. 27, 2008

Related U.S. Application Data
(60) Provisional application No. 61/034,974, filed on Mar. 8, 2008.

(51) Int. Cl. G06K 9/40

(52) U.S. Cl. 382/255

(57) ABSTRACT

A multi-pass algorithm to reduce ringing artifacts in image processing, e.g. from noise removal and deblur effects, is described. One embodiment includes processes: forming a matte of areas in an original image around strong edges to produce an edgeMatte image, e.g. by using an edge detection algorithm to find edges and dilating the detected lines using a matte dilation technique; producing an originalNoEdges image without any of the strong edges; running an image processing algorithm, e.g. denoise or deblur algorithm, on the originalNoEdges image to produce a resultNoEdges image; running the image processing algorithm on the original image to produce a resultWithRinging image; selectively combining the resultNoEdges image and the resultWithRinging image using the edgeMatte image.

### CLAIM OF PRIORITY

This application claims priority to U.S. Provisional Patent Application No. 61/034,974 entitled “Multi-Pass Algorithm To Reduce Ringing Artifacts In Noise Removal And Deblur Effects”, which was filed on Mar. 8, 2008, by Benjamin Kent, the contents of which are expressly incorporated by reference herein.

### BACKGROUND OF THE INVENTION

Most general purpose image and photo editing software have one or more noise reduction functions (median, blur, despeckle, etc). Special purpose noise reduction software programs include Neat Image, Grain Surgery, Noise Ninja, GREYCstoration and pnmnlfilt (nonlinear filter) found in the open source Netpbm tools. General purpose image and photo editing software including Adobe Photoshop, the open source GIMP, Photolmpact and Helicon Filter also feature noise reduction functions.

One method to remove noise in an image is by convolving the original image with a mask. The Gaussian mask comprises elements determined by a Gaussian function. The Gaussian mask method gives the image a blurred appearance if the standard deviation of the mask is high, and has the effect of smearing out the value of a single pixel over an area of the image. This brings the value of each pixel into closer harmony with the value of its neighbors. Gaussian filtering works relatively well, but the blurring of edges can cause problems, particularly if the output is being fed into edge detection algorithms for computer vision applications.

Another method of removing noise in an image is averaging, which sets the value of each specific pixel to the average value of itself and its nearby neighbors. Averaging tends to blur an image, because pixel intensity values which are significantly higher or lower than the surrounding neighborhood will “smear” across the area. Like the Gaussian filter, averaging is an effective noise suppression technique against Gaussian noise as the deviations are normally distributed, and have intensities relatively close to the original value. Also the image could be filtered by a non-linear filter, e.g. a median filter, which if properly designed, is very good at preserving image detail.

Frequency domain based denoising methods include Wiener filtering and wavelet based methods. Wiener filter is based on a statistical approach. Assuming to have knowledge of the spectral properties of the original signal and the noise, and the goal is to find the Linear Time Invariant filter whose output would come as close to the original signal as possible. Wiener filters are characterized by the following:

1. Signal and (additive) noise are assumed to be stationary linear stochastic processes with known spectral characteristics or known autocorrelation and cross-correlation

2. The filter must be physically realizable, i.e. causal (this requirement can be dropped, resulting in a non-causal solution)

3. Minimum mean-square error performance criteria is used.

This filter is frequently used in the process of deconvolution.

A wavelet is a kind of mathematical function used to divide a given function or continuous-time signal into different frequency components and study each component with a resolution that matches its scale. A wavelet transform is the representation of a function by wavelets. The wavelets are scaled and translated copies (known as “daughter wavelets”) of a finite-length or fast-decaying oscillating waveform (known as the “mother wavelet”). In scaling filter, the wavelet is entirely defined by the scaling filter—a low-pass finite impulse response (FIR) filter of length 2N and sum 1. In biorthogonal wavelets, separate decomposition and reconstruction filters are defined. For analysis the high pass filter is calculated as the quadrature mirror filter of the low pass, and reconstruction filters the time reverse of the decomposition. Daubechies and Symlet wavelets can be defined by the scaling filter.

In image deblurring, the goal is to recover the original, sharp image by using a mathematical model of the blurring process itself. Using known details of the blurring process, the blurred image information can be restored.

A number of commonly used image processing algorithms including denoising and deblurring algorithms suffer from unwanted image artifacts known as “ringing”. These artifacts can be described as repeats (or ghosts) of strong edges in the original image. They tend to be separated from these edges by several pixels (dependent on the size of the image and the algorithm used). Therefore, image processing algorithms that reduce the ringing artifacts are desirable.

### SUMMARY OF INVENTION

A multi-pass algorithm to reduce ringing artifacts in image processing, e.g. from noise removal and deblur effects, is described. One embodiment includes processes: forming a matte of areas in an original image around strong edges to produce an edgeMatte image, e.g. by using an edge detection algorithm to find edges and dilating the detected lines using a matte dilation technique; producing an originalNoEdges image without any of the strong edges; running an image processing algorithm, e.g. denoise or deblur algorithm, on the originalNoEdges image to produce a resultNoEdges image; running the image processing algorithm on the original image to produce a resultWithRinging image; selectively combining the resultNoEdges image and the resultWithRinging image using the edgeMatte image.

### BRIEF DESCRIPTION OF THE DRAWINGS

FIG. 1A depicts an example of a blurred image.

FIG. 1B depicts an example of a deblurred image.

FIG. 2A depicts an example of a noisy image.

FIG. 2B depicts an example of a denoised image.

FIG. 3 depicts a flow diagram of one embodiment of a multi-pass algorithm to reduce ringing artifacts resulting from image processing.

FIG. 4 depicts an example of a computer system that implements the present invention.

### DETAILED DESCRIPTION OF EMBODIMENTS OF THE INVENTION

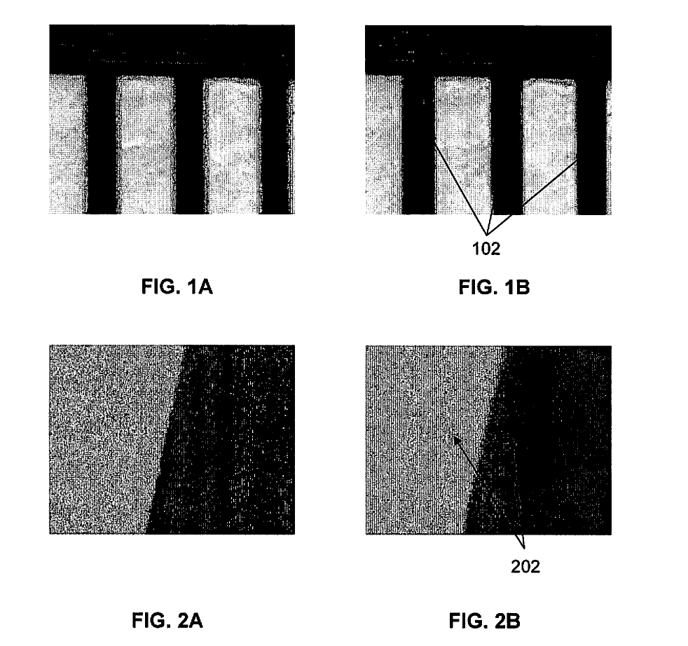

The common drawbacks of image processing algorithms, e.g., denoising and deblurring algorithms, are unwanted image artifacts known as “ringing”, i.e. repeats (or ghosts) of strong edges in the original image separated from these edges by several pixels depending on the size of the image and the algorithm used. They are illustrated in FIGS. 1A, 1B, 2A, and 2B.

FIG. 1A depicts an example of a blurred image. To produce a sharper image, a deblurring algorithm is applied to FIG. 1A.

FIG. 1B depicts an example of a deblurred image. It is the result of the deblurring algorithm applied to FIG. 1A. Even though the image sharpness improved, there are undesirable artifacts, i.e. the “ringing” 102.

FIG. 2A depicts an example of a noisy image. To reduce the noise present in the image, a denoising algorithm is applied to FIG. 2A.

FIG. 2B depicts an example of a denoised image. It is the result of the denoising algorithm applied to FIG. 2A. Even though the image noise is reduced, there are undesirable artifacts, i.e. the “ringing” 202.

To alleviate the ringing artifact from denoising and deblurring algorithms, a multi-pass algorithm described below could be used. Also, the multi-pass algorithm may be used to reduce similar ringing artifacts from other image processing algorithms.

The multi-pass algorithm can be applied in situations with the following circumstances:

1. Ringing is caused by strong edges in an image.
2. The ringing artifacts are separated from the edges that caused them by a number of pixels (determined by the algorithm and the image size).

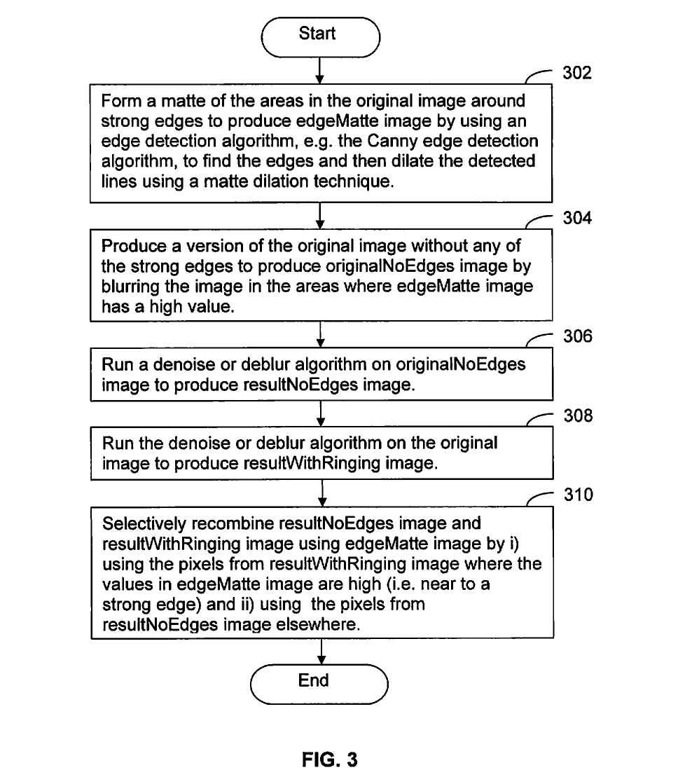

FIG. 3 depicts a flow diagram of one embodiment of a multi-pass algorithm to reduce ringing artifacts resulting from image processing.

Process 302 forms a matte of the areas in the original image around strong edges (e.g. this will have high values near to edges and zero values elsewhere)—we will call this image edgeMatte. One embodiment of this process may perform the following steps.

a. Use an edge detection algorithm, e.g. the Canny edge detection algorithm, to find the edges.

b. Then dilate the detected lines using standard matte dilation techniques.

An edge detection algorithm identifies points in a digital image at which the image brightness changes sharply or more formally has discontinuities. The purpose of detecting sharp changes in image brightness is to capture important events and changes in properties. It can be shown that under rather general assumptions for an image formation model, discontinuities in image brightness are likely to correspond to: discontinuities in depth, discontinuities in surface orientation, changes in material properties and variations in scene illumination.

Applying an edge detector to an image may lead to a set of connected curves that indicate the boundaries of objects, the boundaries of surface markings as well curves that correspond to discontinuities in surface orientation. Thus, applying an edge detector to an image may significantly reduce the amount of data to be processed and may therefore filter out information that may be regarded as less relevant, while preserving the important structural properties of an image. If the edge detection step is successful, the subsequent task of interpreting the information contents in the original image may therefore be substantially simplified.

There are many methods for edge detection, but most of them can be grouped into two categories, search-based and zero-crossing based. The search-based methods detect edges by first computing a measure of edge strength, usually a first-order derivative expression such as the gradient magnitude, and then searching for local directional maxima of the gradient magnitude using a computed estimate of the local orientation of the edge, usually the gradient direction. The zero-crossing based methods search for zero crossings in a second-order derivative expression computed from the image in order to find edges, usually the zero-crossings of the Laplacian or the zero-crossings of a non-linear differential expression. As a pre-processing step to edge detection, a smoothing stage, typically Gaussian smoothing, is often applied.

An example of the edge detection method is Canny edge detection, which uses a smoothing filter with the criteria of detection, localization and minimizing multiple responses to a single edge. The filter is a sum of four exponential terms, which can be well approximated by first-order derivatives of Gaussians. Given the pre-smoothing filters, edge points are defined as points where the gradient magnitude assumes a local maximum in the gradient direction and the edge detection is accomplished by non-maximum suppression.

There are other edge detection methods that may be used for the embodiment of this invention. Other edge detection methods include the Canny-Deriche detector that starts from a discrete viewpoint and then leading to a set of recursive filters for image smoothing instead of exponential filters or Gaussian filters, and other edge-detection operators based upon second-order derivatives of the intensity.

Process 304 produces a version of the original image without any of the strong edges—we will call this image originalNoEdges. One embodiment of this step may be performed by simply blurring the image in the areas where edgeMatte has a high value.

One example of the blurring method is Gaussian blur, which is a widely used effect in graphics software such as Adobe Photoshop, GIMP, Inkscape, and Paint.NET. It is typically used to reduce image noise and reduce detail levels. The visual effect of this blurring technique is a smooth blur resembling that of viewing the image through a translucent screen, distinctly different from the Bokeh effect produced by an out-of-focus lens or the shadow of an object under usual illumination. Gaussian smoothing is also used as a pre-processing stage in computer vision algorithms in order to enhance image structures at different scales.

Mathematically speaking, applying a Gaussian blur to an image is the same as convolving the image with a Gaussian or normal distribution. (In contrast, convolving by a circle (i.e., a circular box blur) would more-accurately reproduce the Bokeh effect.) Since the Fourier transform of a Gaussian is another Gaussian, applying a Gaussian blur has the effect of low pass filtering the image.

Process 306 runs an image processing algorithm, e.g. a denoise or deblur algorithm on originalNoEdges—this will produce resultNoEdges. This image will have no ringing artifacts, but is incorrect in the areas of the strong edges.

As described in the background section of this application, one method to remove noise in an image is by convolving the original image with a mask. The Gaussian mask comprises elements determined by a Gaussian function. The Gaussian mask method gives the image a blurred appearance if the standard deviation of the mask is high, and has the effect of smearing out the value of a single pixel over an area of the image. This brings the value of each pixel into closer harmony with the value of its neighbors. Gaussian filtering works relatively well, but the blurring of edges can cause problems, particularly if the output is being fed into edge detection algorithms for computer vision applications.

Another method of removing noise in an image is averaging, which sets the value of each specific pixel to the average value of itself and its nearby neighbors. Averaging tends to blur an image, because pixel intensity values which are significantly higher or lower than the surrounding neighborhood will “smear” across the area. Like the Gaussian filter, averaging is an effective noise suppression technique against Gaussian noise as the deviations are normally distributed, and have intensities relatively close to the original value. Also the image could be filtered by a non-linear filter, e.g. a median filter, which if properly designed, is very good at preserving image detail.

In image deblurring, the goal is to recover the original, sharp image by using a mathematical model of the blurring process itself. Using known details of the blurring process, the blurred image information can be restored.

Process 308 runs the image processing algorithm again, e.g. the denoise or deblur algorithm, this time on the original image, to produce resultWithRinging. This image will have ringing artifacts, but will be correct in the areas close to the strong edges. The denoise and deblur method are described in previous paragraphs.

Process 310 selectively recombines resultNoEdges and resultWithRinging using edgeMatte to produce the final result. Where the values in edgeMatte are high (i.e. near to a strong edge) use the pixels from resultWithRinging—elsewhere use the pixels from resultNoEdges. By selectively recombining the two images using different sections without ringing artifacts, the ringing artifacts could be removed. In order to smooth the transition between the two recombined images, a blurred version of edgeMatte can be used to select the pixels for the final result. The blurring method is described in previous paragraphs.

While the Canny edge detection algorithm may be used to detect areas of the image with strong edges, any similar edge detection algorithm could also be used. One embodiment of the proposed technique was implemented in C++ on multiple platforms. The technique could also be implemented using any similarly computationally efficient language.

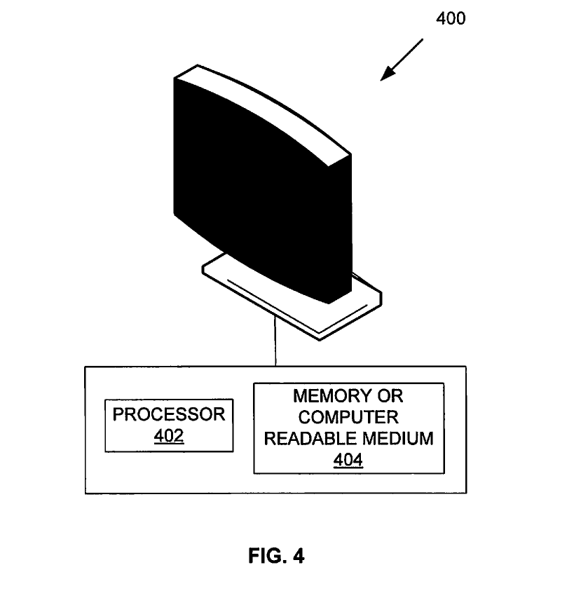

FIG. 4 depicts an example of a computer system that implements one embodiment of the present invention. A computer system 400 includes a processor 402, a memory or computer readable medium 404, and a display 406. A memory or computer readable medium 404 have instructions executable by the processor 402 for reducing artifacts from image processing including: forming a matte of areas in an original image around strong edges to produce an edgeMatte image; producing an originalNoEdges image without any of the strong edges; running an image processing algorithm on the originalNoEdges image to produce a resultNoEdges image; running the image processing algorithm on the original image to produce a resultWithRinging image; selectively combining the resultNoEdges image and the resultWithRinging image using the edgeMatte image. The processor 402 executes the instructions for reducing artifacts from image processing and the display 406 provides a visual interface for a user of the computer system 400. The memory or computer readable medium 404 may include other instructions consistent with the present invention as described in the previous paragraphs.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A method for reducing artifacts from image processing, comprising:
forming a matte of areas in an original image around strong edges to produce an edgeMatte image;
producing an originalNoEdges image without any of the strong edges;
running an image processing algorithm on the originalNoEdges image to produce a resultNoEdges image;
running the image processing algorithm on the original image to produce a resultWithRinging image;
selectively combining the resultNoEdges image and the resultWithRinging image using the edgeMatte image.

2. The method of claim 1, wherein the edgeMatte image has high values near the strong edges and zero values elsewhere.

3. The method of claim 1, wherein forming a matte of areas in an original image around strong edges to produce an edgeMatte image comprises:
using an edge detection algorithm to find edges;
dilating the detected lines using a matte dilation technique.

4. The method of claim 3, wherein the edge detection algorithm is Canny edge detection algorithm.

5. The method of claim 1, wherein producing an originalNoEdges image without any of the strong edges includes blurring the original image in areas where the edgeMatte image has a high value.

6. The method of claim 1, wherein the image processing algorithm is a denoise algorithm.

7. The method of claim 1, wherein the image processing algorithm is a deblur algorithm.

8. The method of claim 1, wherein selectively combining the resultNoEdges image and the resultWithRinging image using the edgeMatte image comprises:
using pixels from the resultWithRinging image where values in the edgeMatte image are high;
using pixels from the resultNoEdges image elsewhere.

9. The method of claim 1, further comprising:
selecting pixels from the resultNoEdges image and the resultWithRinging image using a blurred version of the edgeMatte image.

10. A computer readable medium with instructions for reducing artifacts from image processing, wherein the instructions comprising:
forming a matte of areas in an original image around strong edges to produce an edgeMatte image;
producing an originalNoEdges image without any of the strong edges;
running an image processing algorithm on the originalNoEdges image to produce a resultNoEdges image;
running the image processing algorithm on the original image to produce a resultWithRinging image;
selectively combining the resultNoEdges image and the resultWithRinging image using the edgeMatte image.

11. The computer readable medium of claim 10, wherein the edgeMatte image has high values near the strong edges and zero values elsewhere.

12. The computer readable medium of claim 10, wherein the instruction of forming a matte of areas in an original image around strong edges to produce an edgeMatte image comprises:
using an edge detection algorithm to find edges;
dilating the detected lines using a matte dilation technique.

13. The computer readable medium of claim 12, wherein the edge detection algorithm is Canny edge detection algorithm.

14. The computer readable medium of claim 10, wherein the instruction of producing an originalNoEdges image without any of the strong edges includes blurring the original image in areas where the edgeMatte image has a high value.

15. The computer readable medium of claim 10, wherein the image processing algorithm is a denoise algorithm.

16. The computer readable medium of claim 10, wherein the image processing algorithm is a deblur algorithm.

17. The computer readable medium of claim 10, wherein the instruction of selectively combining the resultNoEdges image and the resultWithRinging image using the edgeMatte image comprises:
using pixels from the resultWithRinging image where values in the edgeMatte image are high;
using pixels from the resultNoEdges image elsewhere.

18. The computer readable medium of claim 10, wherein the instructions further comprising:
selecting pixels from the resultNoEdges image and the resultWithRinging image using a blurred version of the edgeMatte image.

19. A computer system comprising:
a processor;
a memory or computer readable medium with instructions for reducing artifacts from image processing including:
forming a matte of areas in an original image around strong edges to produce an edgeMatte image;
producing an originalNoEdges image without any of the strong edges;
running an image processing algorithm on the originalNoEdges image to produce a resultNoEdges image;
running the image processing algorithm on the original image to produce a resultWithRinging image;
selectively combining the resultNoEdges image and the resultWithRinging image using the edgeMatte image;
a display;
wherein the processor is operable to execute the instructions for reducing artifacts from image processing and the display is operable to provide a visual interface for a user of the computer system.

20. The computer system of claim 19, wherein the instruction of forming a matte of areas in an original image around strong edges to produce an edgeMatte image comprises:
using an edge detection algorithm to find edges;
dilating the detected lines using a matte dilation technique.
